(19) United States
(12) Patent Application Publication
(10) Pub. No.: US 2010/0213213 A1
(43) Pub. Date: Aug. 26, 2010

(54) CLOSURE CAP WITH TAMPERPROOF STRIP

(76) Inventors: Martin Albers, Bundesland (DE); Wolfgang Heukamp, Finnentrop (DE)

Correspondence Address: Oliver Intellectual Property LLC, P.O. Box 1670, Cotuit, MA, 02635, US

(21) Appl. No.: 12/663,408

(22) PCT Filed: Feb. 7, 2008
(86) PCT No.: PCT/EP2008/000921

§ 371 Date: Dec. 7, 2009

(30) Foreign Application Priority Data
Jun. 25, 2007 (DE) 10 2007 029 541.5

(51) Int. Cl. B67B 1/00; B65D 51/00

(52) U.S. Cl. 222/153.05; 222/562; 222/566

(57) ABSTRACT

The invention relates to a closure cap (3) made of plastic for the pouring spout (2) of a container, having a tamperproof strip (5a, 5b) which is arranged along the bottom cape edge (4) and is connected to the cap via at least one frangible web (8), wherein a first end (6) of the tamperproof strip is fastened in a non-releasible manner on the cap, and the second end (7) is fastened on the cap via the frangible web, and wherein, when the cap is screwed open, the second end of the tamperproof strip comes into abutment against a protrusion (10), in particular a step of the spout (2), by means of which the tamperproof strip can be buckled and the frangible web can be severed.

### CROSS-REFERENCE TO RELATED APPLICATIONS

This application is a section 371 of PCT/EP08/00921, filed 7 Feb. 2008 and published 31 Dec. 2008 as WO 2009-000342-A, and further claims priority from DE 10 2007 029 541.5, filed 25 Jun. 2007, the entire content of which is hereby incorporated by reference.

### FIELD OF THE INVENTION

The invention relates to a closure cap made of plastic for the pouring spout of a container, having a tamper-evident strip that is arranged on the lower cap edge and is connected to the cap via at least one frangible web.

### BACKGROUND

In the context of closure caps for containers, it is known to mount the lower edge of the closure cap, by frangible webs, on a tamper-evident ring that is fixed in lossproof fashion on the container spout. When the cap is twisted off and the frangible webs are separated, the tamper-evident ring remains on the spout or container. Separation of the frangible webs occurs in this context as a result of the lifting of the cap while unscrewing, so that considerable pulling forces must be generated while unscrewing. In addition, separation of the frangible webs takes place only after the cap has been twisted several times, so that it may happen that carbon dioxide flows out of the container, in the absence of actuation of the tamper-evident seal.

### SUMMARY OF THE INVENTION

It is an object of the invention to improve a closure cap of the kind cited above in such a way that separation of the frangible webs is accomplished substantially as a result of twisting the cap and not so early on, so that premature opening of the container, in particular premature outflow of gases from the container, is prevented.

This object is achieved according to the present invention in that a first end of the tamper-evident strip is mounted nondetachably on the cap, and the second end is mounted via the frangible web on the cap; and that the second end of the tamper-evident strip comes into contact against a protrusion, in particular a step, of the spout as the cap is twisted for opening, as a result of which contact the tamper-evident strip is compressible and the frangible web is separable.

With a design of this kind, it is not the lifting of the cap but the twisting of the cap that modifies the tamper-evidence, i.e. twisting the cap makes visible the fact that the closure has been opened. Twisting the cap through an angle of only a few degrees already causes the frangible webs to tear off, so that premature opening is reliably prevented. Twisting the cap also causes a permanent deformation of the tamper-evident strip or strips, and the tamper-evident strip also always remains on the cap even after opening.

It is particularly advantageous that the tamper-evident strip is compressible in such a way that the tamper-evident strip bulges outward so that the change in the tamper-evident strip is easily visible.

It is particularly advantageous if the tamper-evident strip comprises, close to the first end, a constriction around which the tamper-evident strip is deflectable, in particular inflectable, upon compression. This ensures on the one hand that the tamper-evident strip is permanently deformed, and on the other hand that good visibility of the deformation is achieved. For this purpose it is also proposed that the tamper-evident strip comprise between the first and the second end, in particular in a central region, at least one constriction as a result of which the tamper-evident strip is inflectable upon compression.

It is preferably proposed that two tamper-evident strips, which each encompass or form substantially half of the cap circumference, be mounted on the lower edge of the cap. This increases the certainty that at least one tamper-evident strip is visibly deformed. It further leads to the advantage that after opening, the tamper-evident strips do not protrude too far, and therefore obtrusively, to the side. This also results in a visually attractive result after the closure is opened.

It is preferably proposed that the pouring spout be mounted on, in particular shaped onto, a welded-in part.

### BRIEF FIGURE DESCRIPTION

An exemplifying embodiment of the invention is depicted in the drawings and will be further described below. In the drawings,

FIG. 1 is a perspective view of the closure on a welded-in part, before opening,

FIG. 2 shows the closure after opening,

FIG. 3 is a view during opening, in a section directly below the lower cap edge, so that all that is visible of the cap is the tamper-evident strips, and

FIG. 4 is the view corresponding to FIG. 3 after separation of the frangible webs.

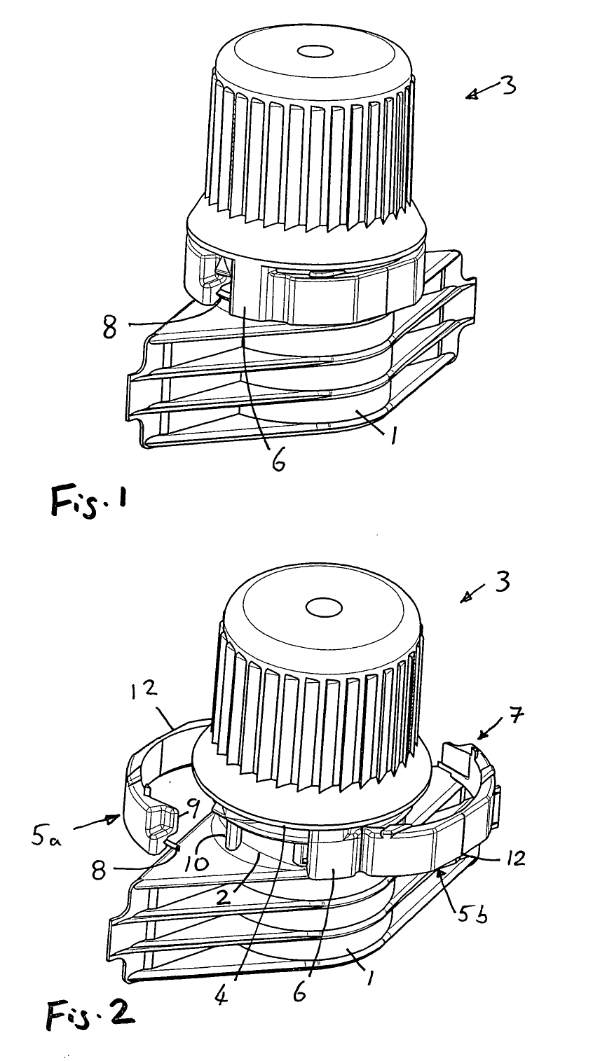

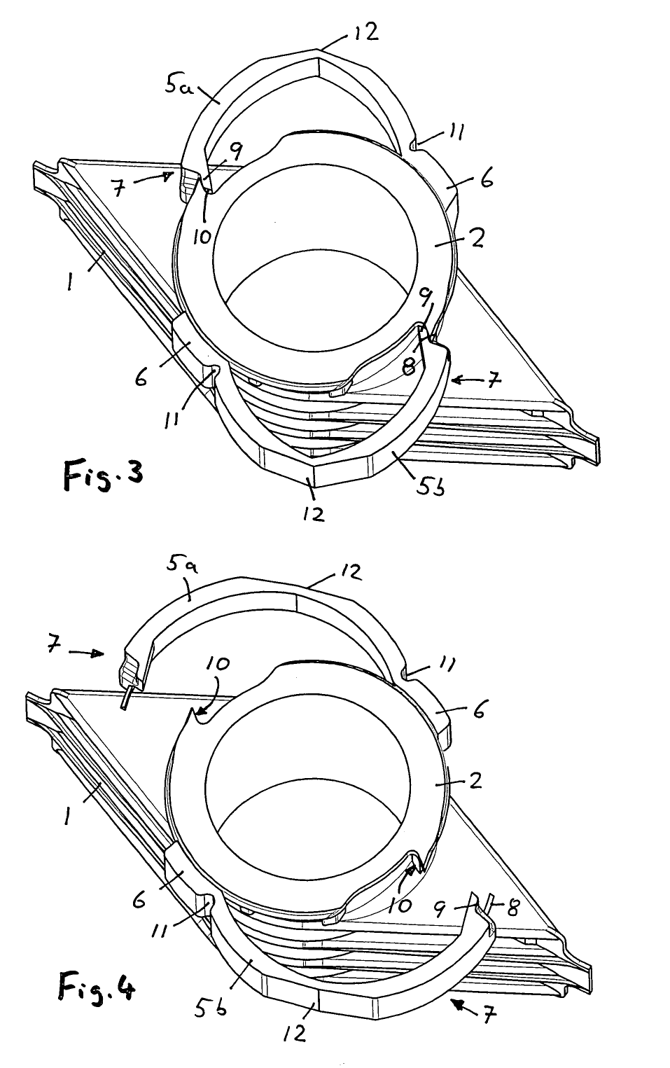

### DETAILED DESCRIPTION

A boat-shaped welded-in part 1 is provided for a container, in particular for a pouch (not depicted), said part being weldable in between the upper wall edges of the pouch and comprising on its upper side a shaped-on pouring spout 2. Pouring spout 2 is closable by means of a screw cap 3 that can be screwed with its internal thread onto the external thread of spout 2.

Two tamper-evident strips 5a and 5b are mounted on lower cap edge 4 in such a way that they project below cap edge 4 and, when the cap is not opened, each form substantially half of the cap circumference in the lower region. A first end 6 of tamper-evident strip 5a, 5b is respectively shaped nondetachably onto the lower side of the cap or onto lower cap edge 4. From this first end 6, the remaining region of tamper-evident strip 5a, 5b extends in the twist-off direction as far as second end 7 of the tamper-evident strip, which is detachably mounted only via a frangible web 8 to the cap, in particular to first end 6 of the other tamper-evident strip.

Second end 7 of tamper-evident strip 5a, 5b forms a contact surface 9 that, when the cap is twisted off, abuts against a protrusion 10 that projects from the outer side of pouring spout 2. Contact surface 9 and protrusion 10 have the effect that once cap 3 has been twisted off through an angle of even a few degrees, contact surface 9 is retained by protrusion 10, and further twisting of cap 3 thus causes tamper-evident strips 5a, 5b to bulge out as long as frangible web 8 has not yet been torn off. This compression and bulging of tamper-evident strips 5a, 5b is further facilitated by the fact that the tamper-evident strip comprises, close to first end 6, a constriction 11 around which the tamper-evident strip is deflectable, in particular inflectable, upon compression; and further by the fact that the tamper-evident strip possesses in its central region, and thus approximately centeredly between the first and the second end, a further constriction 12 that enables broad bulging without allowing frangible web 8 to tear off prematurely. Web 8 tears off, however, after even a slight twisting of the cap, so that premature opening of the container, and premature outflow of gases from the container, is prevented.

Instead of the two tamper-evident strips 5a, 5b depicted in the exemplifying embodiment, a single tamper-evident strip can also be arranged on the lower side of cap 3, said strip then preferably surrounding spout 2 over more than 180 degrees. The spout can also be shaped not onto a welded-in part but instead directly onto a container, in particular onto a bottle.

What is claimed is:

1. A closure cap (3) made of plastic for the pouring spout (2) of a container, having
a tamper-evident strip (5a, 5b) that is arranged on the lower cap edge (4) and is connected to the cap (3) via at least one frangible web (8),
a first end (6) of the tamper-evident strip (5a, 5b) being mounted nondetachably on the cap (3), and the second end (7) being mounted via the frangible web (8) on the cap;
the second end (7) of the tamper-evident strip coming into contact against a protrusion (10) of the spout (2) as the cap (3) is twisted for opening, as a result of which contact the tamper-evident strip (5a, 5b) is compressible and the frangible web (8) is separable; and
the tamper-evident strip (5a, 5b) being compressible in such a way that the tamper-evident strip bulges outward,
wherein
the tamper-evident strip (5a, 5b) comprises, close to the first end (6), a constriction (11) around which the tamper-evident strip is deflectable and inflectable upon compression.

2. The closure cap according to claim 1, wherein the tamper-evident strip (5a, 5b) comprises
between the first and the second end, at least one constriction (12) as a result of which the tamper-evident strip is inflectable upon compression.

3. The closure cap according to claim 1, wherein
two tamper-evident strips (5a, 5b), which each encompass, substantially half of the cap circumference, are mounted on the lower edge (4) of the cap (3).

4. The closure cap according to claim 1, wherein the pouring spout (2) is mounted on a welded-in part (1).

5. The closure cap according to claim 2, wherein
two tamper-evident strips (5a, 5b), which each encompass substantially half of the cap circumference, are mounted on the lower edge (4) of the cap (3).

6. The closure cap according to claim 2, wherein
the pouring spout (2) is mounted on a welded-in part (1).

7. The closure cap according to claim 3, wherein
the pouring spout (2) is mounted on a welded-in part (1).

8. The closure cap according to claim 5, wherein
the pouring spout (2) is mounted on a welded-in part (1).
